(19) United States
(12) Patent Application Publication
(10) Pub. No.: US 2016/0088950 A1
(43) Pub. Date: Mar. 31, 2016

(54) PURSE STOOL

(71) Applicant: JOHNNY GADEA, Miami, FL (US)

(72) Inventor: JOHNNY GADEA, Miami, FL (US)

(21) Appl. No.: 14/497,788

(22) Filed: Sep. 26, 2014

(51) Int. Cl. A47C 9/00; A47C 4/28; A47C 7/62; B60N 2/24

(52) U.S. Cl. CPC A47C 9/00; B60N 2/242; A47C 4/28; A47C 7/62

(57) ABSTRACT

A purse stool is comprised of a purse having the dimensions required to stow a foldable stool in a front pocket of the purse. The purse's pocket has a securing means that allows the purse to drape from the stool when the stool is opened. The securing means is a strip of material that is attached to the material of the sitting portion of the stool and the purse pocket.

### BACKGROUND

The present invention is directed toward a tool that can be used by commuters that catch public transportation, it is a purse stool.

The present invention was conceived when the inventor realized that many times that he passed bus stops, he saw women standing up rather than sitting on the bus benches. Sometimes the bus benches were fully occupied, sometimes the bus benches were not, yet the women chose to stand rather than sit on the benches.

He hypothesized the reason that the women chose to stand when benches were empty was either a fear of the people that were sitting in the benches or because of other sanitary reasons.

The inventor also noticed how the women that waited for public transportation secured their purses. He also realized that they always kept them close to their bodies while waiting for public transportation. This led him to further hypothesize that sometimes women did not sit on benches because of the fear of being assaulted for their purses by transients that typically sit on the benches.

For the foregoing reasons, the inventor developed a device that would allow women waiting for public transportation to sit and secure their purses in a safe manner.

### SUMMARY

The present invention is directed to a device that women can use to sit and secure their purses when using public transportation. The device is portable stool that is housed in a purse pocket.

The purse stool of the present invention is a device that is comprised of a purse having the dimensions required to stow a foldable stool in a front pocket of the purse. The purse's pocket has a securing means that allows the purse to drape from the stool when the stool is opened. The securing means is a strip of material that is attached to the material of the sitting portion of the stool and the purse pocket.

The device is used by women by simply removing the stool from the front pocket. Then opening the stool to an open position and placing the device in the place in which they choose to sit. Then sitting on stool and allowing the purse to be drape either between their legs or under their legs when sitting on the device. In an embodiment of the device, the device would have leg extensions that could be stowed in the frame of the foldable stool.

An object of the present invention is to provide a device that can be used by women who use public transportation to sit on the device.

Another object of the present invention is to provide a device that allows women that use public transportation to carry a foldable stool within their purse.

A further object of the present invention is to provide a foldable stool that is attached to a purse pocket so that when the stool is used the purse is secured to the stool.

### DRAWINGS

These and other features, aspects, and advantages of the present invention will become better understood with regard to the previous description and drawings where:

FIG. 1 is a perspective view of a purse stool;

FIG. 2 is a perspective view of the purse stool's rectangular tubular frames with the leg extensions inserted within the short side of each tubular frame;

FIG. 3 is a perspective view of the rectangular tubular frames in a pivoted position;

FIG. 4 is a perspective view of how the leg extensions are inserted within the opening of the long end of each rectangular tubular frame;

FIG. 5 is a perspective view of how the leg extensions are inserted within the openings of the short end of each rectangular tubular frame;

FIG. 6 is a perspective view showing the stool of the present invention outside of the pocket of the purse;

FIG. 7 is a perspective view showing the present invention in the open position with the purse draping from the stool; and

FIG. 8 shows a user of the present invention sitting on the stool.

### DESCRIPTION

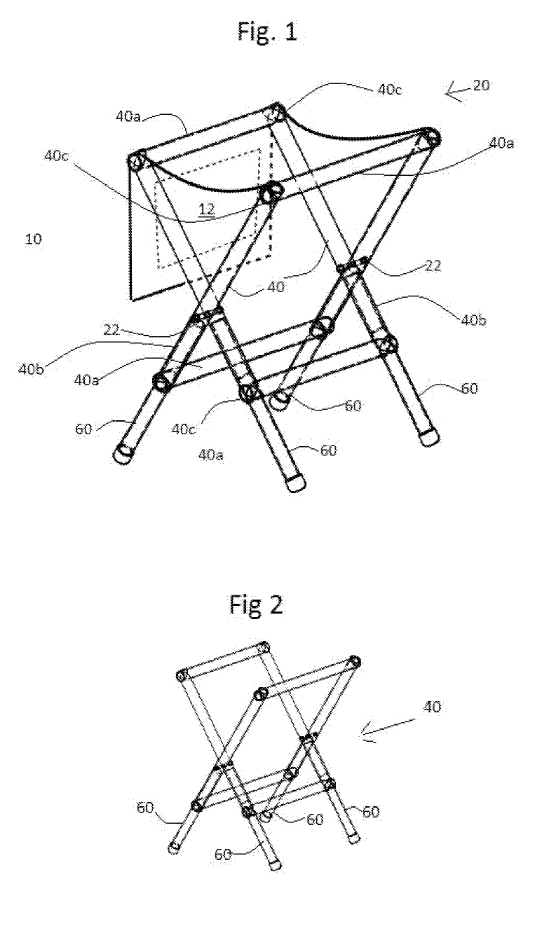

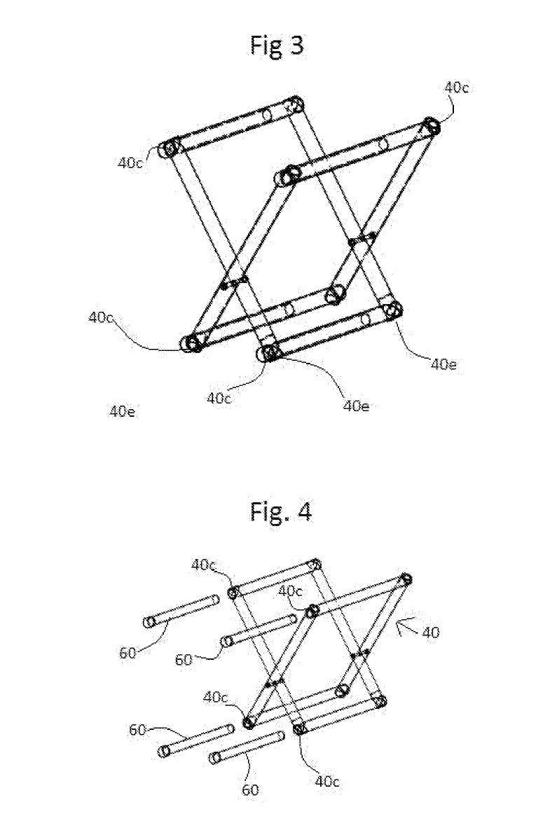

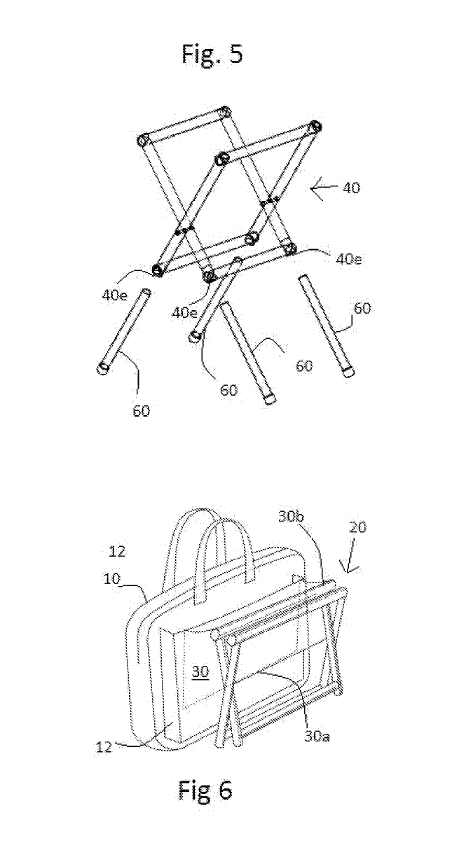

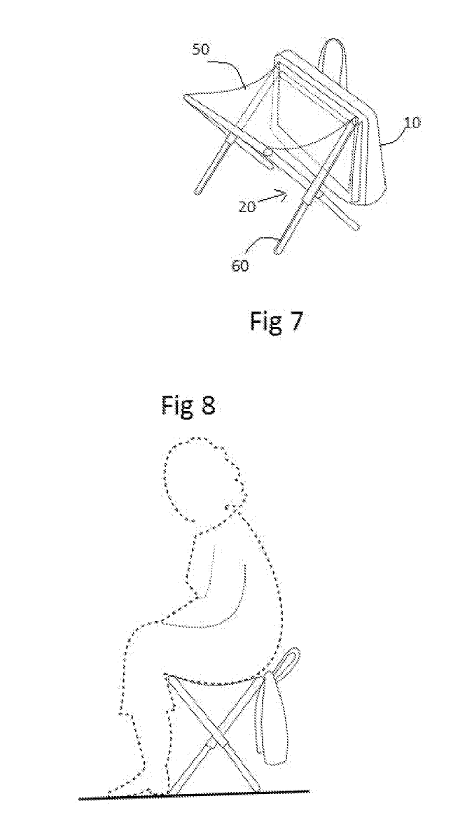

As seen in FIGS. 1-8, the present invention is a purse stool, the purse stool comprises: a purse 10, the purse 10 has a front pocket 12; a strap 30 having a first 30a and a second end 30b, the first end 30a of the strap 30 is attached to the front pocket 12; and a foldable stool 20, the second end of the strap 30b is attached to the foldable stool 20. In an embodiment of the invention the purse pocket 12 has a width of approximately 13 inches and a height of approximately 9 inches.

The foldable stool 20 comprises a pair of rectangular tubular frames 40, each frame 40 having a long side 40a and a short side 40b, the long side 40a defining an opening 40c wherein leg extensions 60 may be housed, one frame 40 having a long side 40a that is slightly shorter than the other frame 40 so that one frame 40 can be placed within the other frame 40 when the frames are pivotally connected, a pivot 22 connects the frames 40 at a distance that is approximately six inches from one of the ends of the short side of the rectangular tubular frames 40; and a rectangular sheet of material 50 that is secured around each long side 40a of each rectangular tubular frame 40, the long side of each rectangular frame 40a in which the sheet 50 is attached is the side that is adjacent to the six inch short side of the rectangular tubular frames 40, the second end of the strap 30b is attached to the rectangular sheet of material 50.

In another embodiment of the present invention, the purse stool comprises of four leg extensions 60, and wherein the short side of each tubular frame 40b defines an opening 40e that is perpendicular to each short side of each tubular frame, each leg extension 60 is inserted within the long side of each tubular frame 40c when the foldable stool 20 is folded and each leg extension 60 is inserted within the short side of each tubular frame 40b when the foldable stool 20 is opened.

An advantage of the present invention is that it provides a device that can be used by women who use public transportation to sit on the device.

Another advantage of the present invention is that it provides a device that allows women that use public transportation to carry a foldable stool within their purse.

A further advantage of the present invention is that it provides a foldable stool that is attached to a purse pocket so that when the stool is used the purse is secured to the stool.

While the inventor's above description contains many specificities, these should not be construed as limitations on the scope, but rather as an exemplification of several preferred embodiments thereof Many other variations are possible. Accordingly, the scope should be determined not by the embodiments illustrated, but by the appended claims and their legal equivalents.

What is claimed is:

1. A purse stool, the purse stool comprises:
A purse, the purse has a front pocket;
A strap having a first and a second end, the first end of the strap is attached to the front pocket; and
A foldable stool, the second end of the strap of is attached to the foldable stool.

2. The purse stool of claim 1, wherein the purse pocket has a width of approximately 13 inches and a height of approximately 9 inches.

3. The purse stool of claim 2, wherein the foldable stool comprises:
A pair of rectangular tubular frames, each frame having a long side and a short side, the long side defining an opening wherein leg extensions may be housed, one frame having a long side that is slightly shorter than the other frame so that one frame can be placed within the other frame when the frames are pivotally connected, a pivot connects the frames at a distance that is approximately six inches from one of the ends of the short side of the rectangular tubular frames; and
A rectangular sheet of material that is secured around each long side of each rectangular tubular frame, the long side of each rectangular tubular frame in which the sheet is attached is the side that is adjacent to the six inch short side of the rectangular tubular frames, the second end of the strap is attached to the rectangular sheet of material.

4. The purse stool of claim 3, that comprises of four leg extensions, and wherein the short side of each tubular frame defines an opening that is perpendicular to each short side of each tubular frame, each leg extension is inserted within the long side of each tubular frame when the foldable stool is folded and each leg extension is inserted within the short side of each tubular frame when the stool is opened.
